(19) United States
(12) Patent Application Publication
(10) Pub. No.: US 2007/0274627 A1
(43) Pub. Date: Nov. 29, 2007

(54) CABLE SEGMENT FOR COMMUNICATION INFRASTRUCTURE

(75) Inventors: Alain Perrin, Saint Nicolas De Macherin (FR); Sebastian Schreiber, Berlin (DE); Hannes Bauer, Dortmund (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Schneider Electric Industries SAS, Rueil-Malmaison (FR)

(21) Appl. No.: 11/680,229

(22) Filed: Feb. 28, 2007

(30) Foreign Application Priority Data
Mar. 21, 2006 (FR) 06 50961

(51) Int. Cl. G02B 6/28

(52) U.S. Cl. 385/24

(57) ABSTRACT

The present invention relates to a cable segment (2) and a communication infrastructure comprising such a cable segment (2). This cable segment comprises:
several pairs of optical fibres (21),
an end connector (22a, 22b) located at each end of the segment (2) and comprising all the pairs (21) of optical fibres, characterized in that
each pair (21) of optical fibres is interrupted at least once to form a tapping point (23) comprising two connection points (24a, 24b).

### BACKGROUND OF THE INVENTION

1. Field of the invention

The present invention relates to a cable segment for a communication infrastructure comprising several pairs of optical fibres. The invention also relates to a communication infrastructure comprising at least one cable segment. The infrastructure can comprise several segments connected end-to-end.

2. Description of the prior Art

A computer communication infrastructure operating under a protocol, for example of Ethernet, ATM or Token Ring type, can have a number of different topologies. The best known topologies are star, bus and ring.

In a star topology, servers are linked to a main hub extending via several branches in a star towards a number of secondary appliances to which the computer terminals are, for example, connected directly or via network switches. Typically, in a local infrastructure, the main hub is located in a central room of a building and the secondary appliances are remotely sited in rooms located as close as possible to the computer terminals of the end users.

The branches linking the main hub to the secondary appliances are, for example, implemented in optical fibres. Compared to a coaxial cable or a twisted pair, optical fibre allows far higher bit rates, possibly ranging beyond 1 gigabit per second. Furthermore, it has numerous other advantages linked in particular to the immunity of the signal along the optical fibre, the reliability and the dependability of transmission over long distances.

However, when a new secondary appliance needs to be installed or linked to the main hub, the star topology requires a new optical fibre cable to be pulled from the main hub to the secondary appliance. Now, the custom installation of an optical fibre cable is often costly and needs to be entrusted to specialists.

A communication infrastructure having a bus topology provides a way of overcoming this problem. In a bus topology, a single cable is connected to the main hub and this cable has a number of taps over its entire length, leading to the secondary appliances. The quantity of cable to be pulled between the bus and the secondary appliances is therefore reduced and easier to install. However, when the cable is of optical fibre and has, for example, one pair of optical fibres, each tap set up on the optical fibre pair to a secondary appliance causes the signal to be attenuated. Furthermore, currently, setting up a tap on an optical fibre cable is not very practical to implement. Documents WO 97/41476 and U.S. Pat. No. 4,941,720 describe means for providing a tap on an optical cable. However, these documents do not describe how to easily construct a communication infrastructure based on good quality optical fibres.

### SUMMARY OF THE INVENTION

The aim of the invention is therefore to be able to construct a communication infrastructure based on optical fibres simply, that is without pulling numerous cables and without requiring specialists, while ensuring a best quality of service for the end user.

This aim is achieved by a pre-equipped cable segment used in a communication infrastructure, comprising:
several pairs of optical fibres,
an end connector located at each end of the segment and grouping together all the pairs of optical fibres, characterized in that
each pair of optical fibres is interrupted once to form a tapping point comprising two connection points,
the tapping points are staged along the cable segment.

A communication infrastructure constructed from segments according to the invention can be likened to a bus topology. This infrastructure therefore comprises in particular the advantages associated with the ease of installation of an infrastructure having a bus topology but also those linked to the quality of service specific to a star topology infrastructure. The use of the segments according to the invention therefore makes it possible in particular to set up different types of known topologies, such as star or daisy-chain topologies.

According to the invention, the segment comprises several pairs of optical fibres and therefore comprises several tapping points, for example staged along the segment. Constructing a local communication infrastructure is therefore easy, since it is set up simply by joining several segments end-to-end. Furthermore, adding a secondary appliance presents no difficulty because each segment has tapping points pre-equipped with connectors. The tap from the optical fibre thus makes it possible to bring a high bit-rate signal at least to the secondary appliance and therefore as close as possible to the end user's terminal.

According to the invention, the use of segments of the type described in this application allows for a high degree of modularity, not only in the assembly and installation of a communication infrastructure, but also in the choice of the topology implemented.

According to a particular feature of the invention, the segment comprises a connection device comprising portions of optical fibres suitable for linking the two connection points. This connection device is connected to the tapping point when the tapping point is not used, to ensure the continuity of transmission of the data along the pair of optical fibres.

According to another particular feature, at each connection point, two optical fibres are combined in one optical connector.

According to another particular feature, at the tapping point, the tap is made perpendicular or parallel to the pairs of optical fibres.

According to a particular embodiment of the invention, a tapping point is formed on an end connector.

According to a particular feature of the invention, one end connector is of female type and the other end connector is of male type. This makes it possible to connect as many segments as necessary end-to-end.

According to another particular feature, the end connectors are multi-fibre, for example of MPO, MF or MTP type.

According to the invention, the segment comprises six pairs of optical fibres. With a tapping point for each pair of optical fibres, the segment therefore comprises six tapping points, for example distributed over the length of the segment.

According to the invention, such a segment is particularly well suited for installation in a communication infrastructure operating under a protocol allowing for the transfer of data by optical fibres such as, for example, Ethernet, ATM or “Token Ring”.

The aim of the invention is also to propose a communication infrastructure comprising at least one hub linked to a first end of a transmission line comprising at least one cable segment as defined above, said hub being suitable for sending data over each pair of optical fibres of the transmission line.

According to a first variant of embodiment of this infrastructure, the transmission line has a second end connected to the hub by a return optical link.

According to a second embodiment variant, the transmission line has a second end to which the pairs of optical fibres are connected two by two via a connector.

According to a third embodiment variant, the transmission line has a second end connected to a second hub suitable for sending data over each pair of optical fibres of the transmission line.

According to a particular feature of the infrastructure, the hub comprises one or several multi-fibre connectors to connect one end of the transmission line.

According to the invention, the transmission line comprises several segments connected end-to-end or connected to each other via one or more transport cables.

This communication infrastructure is particularly well suited to operate under a protocol allowing for the transfer of data by optical fibres such as, for example, Ethernet, ATM or “Token Ring”.

### BRIEF DESCRIPTION OF THE DRAWINGS

Other characteristics and advantages will become apparent from the detailed description that follows, by referring to an embodiment given by way of example and represented by the appended drawings, in which:

FIG. 1 diagrammatically shows a communication infrastructure according to the invention,

FIG. 2 represents a cable segment according to the invention comprising several optical fibre pairs,

FIG. 3 diagrammatically represents a variant of the communication infrastructure according to the invention,

FIG. 4 represents an end loopback connector that can be used in a communication infrastructure according to the invention,

FIG. 5 represents a variant of the tapping point of a segment according to the invention,

FIG. 6 shows a cross-sectional representation of a tapping point of a cable segment according to the invention to which an optical cable is connected,

FIG. 7 shows a cross-sectional representation of the tapping point of FIG. 6 on which is fitted a connection device ensuring the continuity of the interrupted optical fibre pair,

FIGS. 8 and 9 represent, seen from outside, the tapping point respectively facing an optical cable or the connection device.

### DETAILED DESCRIPTION

A local computer communication infrastructure operating under a protocol allowing for the transfer of data by optical fibres such as, for example, Ethernet, ATM or “Token Ring”, comprises a main hub 1 at the head, which can, for example, be active, having input connections 10 to receive different inputs, in particular optical, originating from servers and from the output connections 11 transmitting optical signals, for example in parallel, over several optical fibres of a transmission line. The output connections 11 can, for example, be connectors suited to the connector system (MPO, SC, ST, etc.) of the main hub on one side and multi-fibre, for example of MPO (multi-fibre push-on), MF or MTP (registered trademark) type on the other to receive an additional multi-fibre connector, for example of MPO, MF or MTP type from the transmission line. The MTP, MF and MPO connectors are well known, so they are not described in this application. The connectors used are, for example, twelve-fibre connectors.

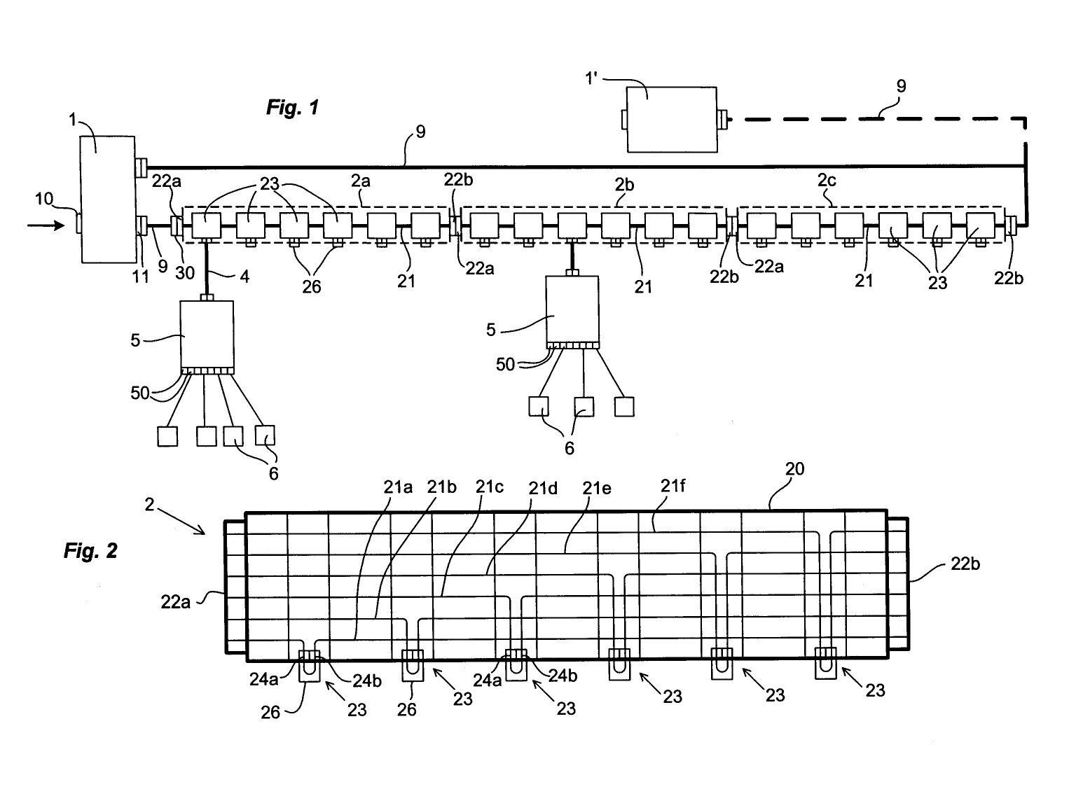

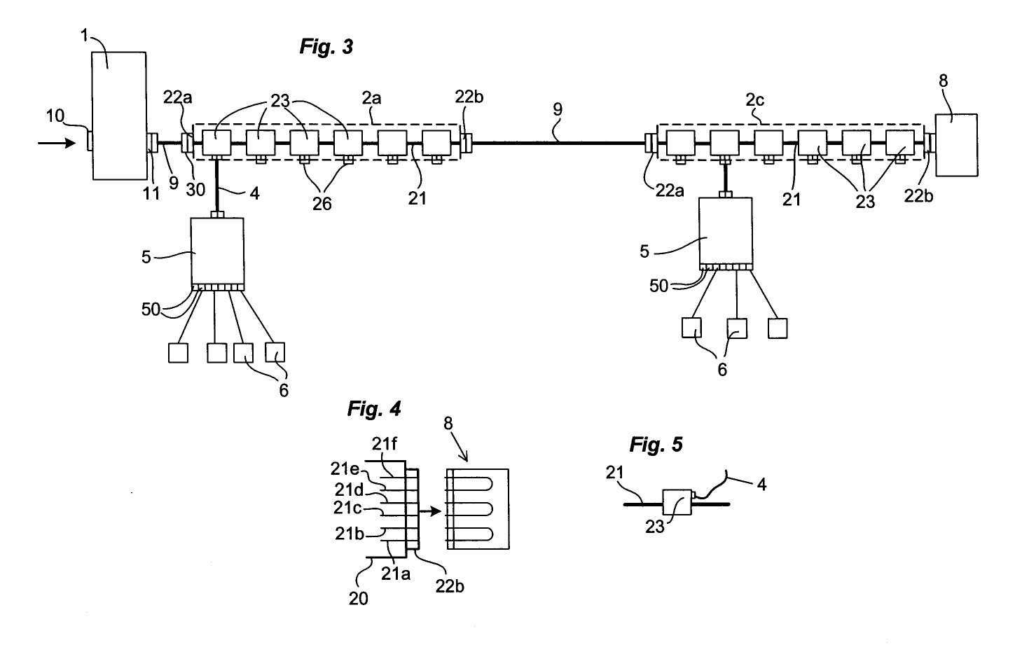

According to the invention, the optical fibre transmission line is made up of several identical segments 2, 2a, 2b, 2c of optical fibres connected end-to-end (FIG. 1) or, possibly, segregated from each other by one or more transport optical cables 9 (FIG. 3). The optical fibres used are, for example, of OM2 type.

A transport optical cable 9 is an uninterrupted cable having multi-fibre connectors, for example of MPO, MF or MTP type, suited in particular to the end connectors 22a, 22b of the segments 2 and to the output connections 11 of the main hub 1.

With reference to FIG. 2, each cable segment is, for example, made up of a flexible cable or conduit 20, passed through along its axis by several parallel pairs 21a, 21b, 21c, 21d, 21e, 21f (21 below) of optical fibres, for example six pairs 21 of optical fibres. The optical fibres are always arranged in pairs, one of the optical fibres of a pair being dedicated to sending data and the other to receiving data. The arrangement of the pairs 21 of optical fibres in a conduit can, in particular, offer advantages in the method of producing the segment 2 of the invention.

The cable 20 has at each end a connector 22a, 22b grouping together the various pairs 21 of optical fibres. These end connectors 22a, 22b are, for example, multi-fibre connectors, for example of MPO (multi-fibre push-on), MF or MTP type. One of the end connectors 22a, 22b of the segment 2 is, for example, a male connector and the other end connector is a female connector. The end connector 22a located at the head makes it possible to connect the segment 2a directly to an additional connector 11 of the main hub 1 or to an additional connector 30 of a multi-fibre transport optical cable 9 leading to the main hub 1 (FIG. 1). The opposite end connector 22b of the segment 2a is suitable for receiving the additional connector 22a of an adjacent identical segment 2b (FIG. 1) or that of a transport optical cable 9 leading, for example, to another segment 2c (FIG. 3). If the cable 20 contains six pairs 21 of optical fibres, the end connectors 22a, 22b of each segment 2 and the connectors of any transport optical cable 9 between two segments 2 are twelve-fibre connectors.

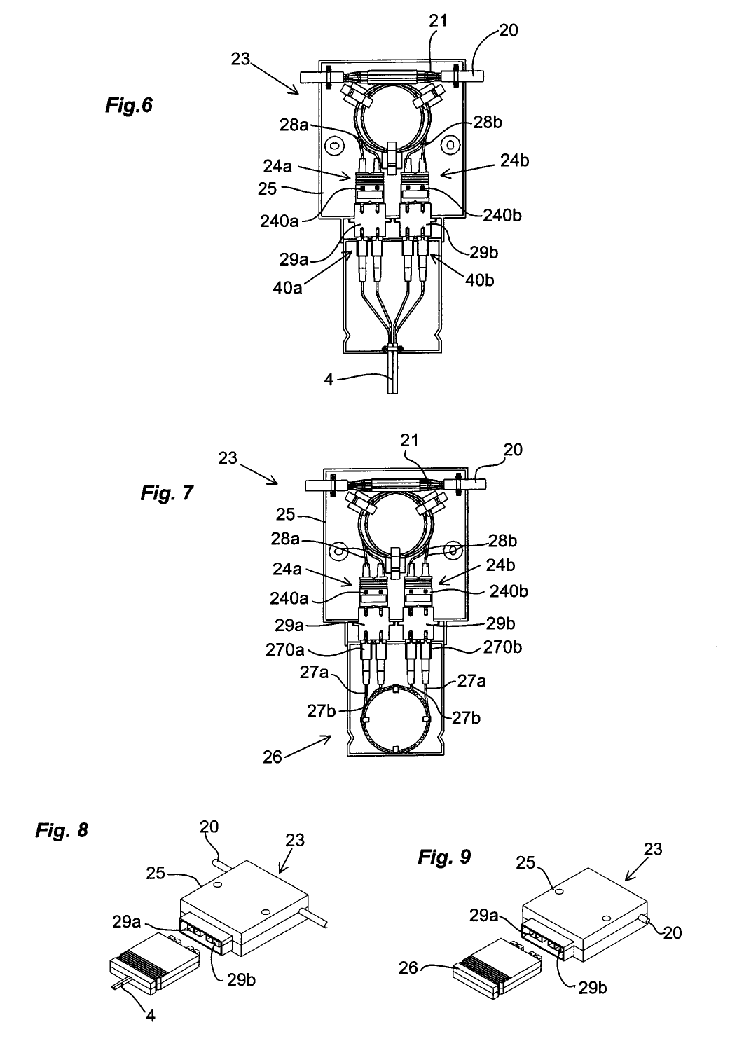

On each cable segment 2, each pair 21 of optical fibres has, for example, at least one tapping point 23, preferably a single tapping point. At each tapping point 23, a pair 21 of optical fibres is interrupted so as to present four optical terminations, two terminations for the incoming pair of fibres and two terminations for the outgoing pair of fibres. The two terminations of the incoming pair of fibres lead to a first connection point 24a, for example via two connecting optical fibres 28a, and the two terminations of the outgoing pair of fibres lead to a second connection point 24b, for example via two connecting optical fibres 28b (FIG. 6). Each of the connection points 24a, 24b therefore has two optical fibres. The connection points 24a, 24b can each be implemented by one or more separate optical connectors or by one common optical connector combining the two connection points 24a, 24b (variant not shown). In FIG. 6, each connection point 24a, 24b is embodied by a separate optical connector 240a, 240b. The two optical connectors 240a, 240b are combined in a module 25 mounted, for example, on the cable 20 of the segment 2 (FIG. 2). If connecting optical fibres 28a, 28b are used, they need to be of sufficient length to join the cable 20 to the connection points 24a, 24b, while facilitating the production method. If the connecting optical fibres are too long, they are wound inside the module 25 (FIG. 6). An optical adapter 29a, 29b can be provided on each optical connector 240a, 240b to facilitate the centring of an additional connection (FIGS. 8 and 9).

According to the invention, the tap from each pair 21 can be oriented perpendicularly to the cable 20 (FIGS. 1 and 3) or parallel to the latter (FIG. 5) according to the orientation of the optical connectors 240a, 240b in the module 25.

An optical jumper type cable 4 having four optical fibres and leading, for example, to a secondary appliance 5 that can also be active, can thus be connected to each of the tapping points 23 of a segment 2 (FIGS. 1 and 6). This cable 4 has two connectors 40a, 40b additional to the optical connectors 240a, 240b of the tapping point 23 to be connected to a tapping point 23 of a segment 2. The secondary appliance 5 connected to the optical connectors 240a, 240b is an appliance of a star-type topology or an intermediate appliance in daisy-chain topology.

If several segments 2 are connected end-to-end (FIG. 1) or via one or more transport cables (FIG. 3), each pair 21 of optical fibres therefore behaves like a bus. However, if, at a tapping point 23, a secondary hub is connected only to one of the optical connectors 240a, 240b of the chain, the connected secondary appliance is an appliance of a simple star-type topology or an appliance located at the end of a daisy-chain topology. In the latter case, several secondary appliances 5 are connected at tapping points 23 of one and the same pair 21 of optical fibres to form a daisy-chain topology. This topology possibly being terminated by an end secondary appliance 5 connected only to one of the optical connectors 240a, 240b of a tapping point 23.

According to the invention, the tapping points nearest to the ends of the segment 2 can also be formed directly on each of the end connectors (variant not shown).

The tapping points 23 are staged along the cable segment 2, that is, distributed at regular intervals along the latter. Each segment 2 comprises, for example, six pairs 21 of optical fibres. Since a tapping point 23 is set up on each pair 21 of fibres, the segment therefore comprises in this case six tapping points 23 distributed over its entire length. On each segment 2, it is therefore possible to connect six secondary appliances 5. Each secondary appliance 5 comprises, for example, eight ports 50, each making it possible to directly link a computer terminal 6 or, where appropriate, several computer terminals (not shown).

Naturally, it would be possible to provide for a greater number of tapping points 23 on one and the same pair 21 of optical fibres and/or to set up a segment 2 with more than six pairs 21 of optical fibres.

If a tapping point 23 is not connected, a connecting device between the two connection points 24a, 24b is used to ensure the continuity of the pair 21 of optical fibres (FIGS. 7 and 9). This connecting device typically takes the form of a cap 26 that may be joined to the module 25 of the tapping point 23. This cap 26 incorporates two portions 27a, 27b of optical fibres having four terminations combined in pairs in two optical connectors 270a, 270b. Each of the portions 27a, 27b can act as the junction between the two connection points 24a, 24b of the tapping point 23 when this tapping point is not used, by connecting each of the optical connectors 270a, 270b of the cap 26 in a corresponding connector 240a, 240b of the tapping point 23. If the two fibre portions 27a, 27b are too long in the cap, they can be wound inside the cap 26. With reference to FIGS. 1 to 3, a connecting device according to the invention is inserted at each tapping point 23 not connected to a secondary appliance 5 to ensure the continuity of the transmission of the data along the pair 21 of optical fibres.

In FIG. 1, the segments 2 are connected end-to-end via additional end connectors 22a, 22b. The transmission line therefore comprises, for example, three segments 2a, 2b, 2c connected end-to-end. This number is not limiting even if, in reality, depending on the number of taps set up on each segment 2, it is important to be careful to retain a sufficiently strong signal at the end of the transmission line. As represented in FIG. 3, it is also possible to provide for connecting two segments 2a, 2c via at least one transport optical cable 9 having multi-fibre connectors, for example of MPO, MF or MTP type, to be connected to each of the segments 2a, 2c.

According to the invention, the use of the segments 2 allows for a high degree of modularity not only in the assembly and installation of a communication infrastructure, but also in the choice of the topology of that infrastructure.

A communication infrastructure including one or more segments 2 according to the invention can be produced according to the following variants:

According to a first embodiment variant, the hub is connected to the transmission line and sends signals over the pairs 21 of optical fibres of the line. According to this configuration, no signal loopback is provided. Thus, if the signal present on a transmit fibre of a pair 21 is cut (break in the fibre or loss of a secondary appliance), all the terminals located on that fibre, downstream of the break point, no longer receive any signal.

According to a second embodiment variant represented in FIGS. 3 and 4, it is possible to provide, at the end of the transmission line, a loopback connector 8 that makes it possible to interlink the pairs 21 of optical fibres. The diagram of such a connector is represented in FIG. 4. In this FIG. 4, the pairs 21a, 21b, 21c, 21d, 21e, 21f of optical fibres can be interconnected two-by-two via the loopback connector 8. Thus, for example, even if the signal is cut on one fibre of a pair 21 (break in the fibre or loss of a secondary appliance), the signal can still reach the terminals 6 located downstream of the break point by using the pair of fibres located in parallel.

According to a third embodiment variant, the transmission line can be looped back using a multi-fibre transport optical cable 9 connected to the end connector 22b of the tail segment 2c to link the transmission line to the main hub 1 (FIG. 1). Thus, the main hub has two possible paths for sending the signals, for example in parallel, over the optical fibres of the transmission line.

According to a fourth embodiment variant of the invention (9 in broken lines in FIG. 1), the transmission line formed, for example by the assembly of the segments 2a, 2b, 2c, can be linked at each end to a different main hub 1, 1′. In this case, each of the main hubs 1, 1′ is connected to the central servers and can receive data from these servers to transmit it, for example in parallel, over the pairs of fibres of the transmission line. In this variant, the return optical cable 9 (FIG. 1) drawn in a solid line is no longer necessary.

According to the invention, various production methods can be envisaged to produce a cable segment 2 pre-equipped according to the invention. One method can consist in cutting all the pairs 21 of optical fibres, in setting up the tap on the pair concerned then in re-welding the other pairs 21, for example by fusion welding. Another method can involve combining the pairs 21 of fibres in a conduit and setting up the tap on just one of the pairs by pulling on the latter without cutting the other pairs. Another method can consist in grasping the pair 21 of fibres to be tapped, and heating it in order to stretch the two fibres to be able to set up the tap.

Obviously it is possible, without departing from the framework of the invention, to imagine other variants and detail refinements and even envisage the use of equivalent means.

1. Pre-equipped cable segment (2) used in a communication infrastructure, comprising:
several pairs of optical fibres (21),
an end connector (22a, 22b) located at each end of the segment (2) and grouping together all the pairs (21) of optical fibres, characterized in that
each pair (21) of optical fibres is interrupted once to form a tapping point (23) comprising two connection points (24a, 24b),
the tapping points (23) are staged along the cable segment (2).

2. Segment according to claim 1, characterized in that it comprises a connection device (26) comprising portions of optical fibres (27a, 27b) suitable for linking the two connection points (24a, 24b).

3. Segment according to claim 1 or 2, characterized in that, at each connection point (24a, 24b), two optical fibres are combined in one optical connector (240a, 240b).

4. Segment according to one of claims 1 to 3, characterized in that, at the tapping point (23), the tap is made perpendicular or parallel to the pairs (21) of optical fibres.

5. Segment according to one of claims 1 to 4, characterized in that a tapping point (23) is formed on an end connector (22a, 22b).

6. Segment according to one of claims 1 to 5, characterized in that one end connector (22b) is of female type and the other end connector (22a) is of male type.

7. Segment according to one of claims 1 to 6, characterized in that the end connectors (22a, 22b) are multi-fibre.

8. Segment according to one of claims 1 to 7, characterized in that it comprises six pairs (21a, 21b, 21c, 21d, 21e, 21f) of optical fibres.

9. Segment according to one of claims 1 to 8, characterized in that the communication infrastructure operates under the Ethernet protocol.

10. Communication infrastructure, characterized in that it comprises at least one hub (1) linked to a first end of a transmission line comprising at least one cable segment (2) according to one of claims 1 to 9, said hub being suitable for sending data over each pair (21) of optical fibres of the transmission line.

11. Infrastructure according to claim 10, characterized in that the transmission line has a second end connected to the hub (1) via a return optical link (9).

12. Infrastructure according to claim 10, characterized in that the transmission line has a second end connected to a second hub (1′) suitable for sending data over each pair (21) of optical fibres of the transmission line.

13. Infrastructure according to claim 10, characterized in that the transmission line has a second end to which the pairs (21) of fibres are connected two by two via a connector (8).

14. Infrastructure according to one of claims 10 to 13, characterized in that the hub (1, 1′) comprises a multi-fibre connector (11) to connect one end of the transmission line.

15. Infrastructure according to one of claims 10 to 14, characterized in that the transmission line comprises several segments (2a, 2b, 2c) connected end-to-end or connected to each other via one or more transport cables (9).

16. Infrastructure according to one of claims 10 to 15, characterized in that it operates under the Ethernet protocol.
